(19) United States
(12) Patent Application Publication
(10) Pub. No.: US 2010/0067777 A1
(43) Pub. Date: Mar. 18, 2010

(54) EVALUATION PATTERN GENERATING METHOD, COMPUTER PROGRAM PRODUCT, AND PATTERN VERIFYING METHOD

(76) Inventors: Katsuyoshi Kodera, Kanagawa (JP); Satoshi Tanaka, Kanagawa (JP); Shimon Maeda, Tokyo (JP); Suigen Kyoh, Kanagawa (JP); Soichi Inoue, Kanagawa (JP); Ryuji Ogawa, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/536,900

(22) Filed: Aug. 6, 2009

(30) Foreign Application Priority Data
Aug. 7, 2008 (JP) 2008-204648

(51) Int. Cl. G06K 9/00

(52) U.S. Cl. 382/144

(57) ABSTRACT

An evaluation pattern generating method including dividing a peripheral area of an evaluation target pattern into a plurality of meshes; calculating an image intensity of a circuit pattern when the evaluation target pattern is transferred onto a wafer by a lithography process in a case where a mask function value is given to a predetermined mesh; calculating a mask function value of the mesh so that a cost function of the image intensity, in which an optical image characteristic amount that affects a transfer performance of the evaluation target pattern to the wafer is set to the image intensity, satisfies a predetermined reference when evaluating a lithography performance of the evaluation target pattern; and generating an evaluation pattern corresponding to the mask function value.

### CROSS-REFERENCE TO RELATED APPLICATIONS

This application is based upon and claims the benefit of priority from the prior Japanese Patent Application No. 2008-204648, filed on Aug. 7, 2008; the entire contents of which are incorporated herein by reference.

### BACKGROUND OF THE INVENTION

1. Field of the Invention

The present invention relates to an evaluation pattern generating method, a computer program product, and a pattern verifying method

2. Description of the Related Art

In recent years, with the miniaturization of a large scale integration (LSI), a minimum line width on a semiconductor circuit is required to be a half or less of a light source wavelength of an exposure apparatus. Due to the miniaturization of LSI, a phenomenon in which a pattern cannot be transferred by exposure onto a wafer as designed, that is, optical proximity effects (OPE), has become obvious. Therefore, since the late 1990s, a technique of finishing a transferred shape according to a desired design pattern by using a corrected mask pattern, that is, optical proximity correction (OPC), has been employed. With this technique, a critical dimension (CD) variation on the wafer can be reduced, whereby it is becoming possible to form a fine pattern appropriately on the wafer as designed.

However, a margin to a process variation cannot be improved only by the OPC in some cases, so that occurrence of a so-called hot spot (a portion with less lithography margin) has been increasing as a normalized dimension (k1) of a pattern becomes smaller. As a method of reducing occurrence of the hot spot, a design for manufacturing (DFM) technique, such as a data correction before fixing a design by a lithography compliance check (LCC) or adapting Hot Spot Correction (HSPC) after fixing data, is beginning to be applied.

As a method of extracting a hot spot when designing and verifying a layout of a semiconductor device using the DFM technique, for example, Japanese Patent Application Laid-open No. 2008-98588 discloses a method of extracting a hot spot by using, in addition to an extracting reference in a film thickness direction, an extracting reference in a direction perpendicular to the film thickness direction. In this method, an analysis target area (a functional block pattern) is divided into grids based on layout data of the semiconductor device, and a film thickness and a level difference are determined for each grid in simulation. Then, it is determined whether each grid corresponds to a hot spot using the extracting references in the film thickness direction and the direction perpendicular to the film thickness direction based on the result of the simulation.

However, the above technique only verifies occurrence of a hot spot by arranging an appropriate pattern on the periphery, stability to the peripheral environment is not sufficiently ensured. Moreover, a plurality of peripheral environments needs to be prepared to ensure the stability to the peripheral environment, which requires extremely long turn around time (TAT) and high cost.

### BRIEF SUMMARY OF THE INVENTION

An evaluation pattern generating method according to an embodiment of the present invention comprises: dividing a peripheral area of an evaluation target pattern that is any one of a circuit pattern of a semiconductor circuit and a mask pattern corresponding to the circuit pattern into a plurality of meshes; first calculating including calculating an image intensity of the circuit pattern when the evaluation target pattern is transferred onto a wafer by a lithography process in a case where a mask function value is given to a predetermined mesh; second calculating including calculating a mask function value of the mesh so that a cost function of the image intensity, in which an optical image characteristic amount that affects a transfer performance of the evaluation target pattern to the wafer is set to the image intensity, satisfies a predetermined reference when evaluating a lithography performance of the evaluation target pattern; and generating a pattern corresponding to the mask function value at the mesh as an evaluation pattern of the evaluation target pattern, which is arranged on a periphery of the evaluation target pattern.

A computer program product for causing a computer to perform according to an embodiment of the present invention comprises: dividing a peripheral area of an evaluation target pattern that is any one of a circuit pattern of a semiconductor circuit and a mask pattern corresponding to the circuit pattern into a plurality of meshes; first calculating including calculating an image intensity of the circuit pattern when the evaluation target pattern is transferred onto a wafer by a lithography process in a case where a mask function value is given to a predetermined mesh; second calculating including calculating a mask function value of the mesh so that a cost function of the image intensity, in which an optical image characteristic amount that affects a transfer performance of the evaluation target pattern to the wafer is set to the image intensity, satisfies a predetermined reference when evaluating a lithography performance of the evaluation target pattern; and generating a pattern corresponding to the mask function value at the mesh as an evaluation pattern of the evaluation target pattern, which is arranged on a periphery of the evaluation target pattern.

A pattern verifying method according to an embodiment of the present invention comprises: dividing a peripheral area of an evaluation target pattern that is any one of a circuit pattern of a semiconductor circuit and a mask pattern corresponding to the circuit pattern into a plurality of meshes; first calculating including calculating an image intensity of the circuit pattern when the evaluation target pattern is transferred onto a wafer by a lithography process in a case where a mask function value is given to a predetermined mesh; second calculating including calculating a mask function value of the mesh so that a cost function of the image intensity, in which an optical image characteristic amount that affects a transfer performance of the evaluation target pattern to the wafer is set to the image intensity, satisfies a predetermined reference when evaluating a lithography performance of the evaluation target pattern; generating a pattern corresponding to the mask function value at the mesh as an evaluation pattern of the evaluation target pattern, which is arranged on a periphery of the evaluation target pattern; arranging the evaluation pattern on a periphery of the circuit pattern; and verifying the lithography performance of the circuit pattern.

### BRIEF DESCRIPTION OF THE DRAWINGS

FIG. 1 is a schematic diagram for explaining a concept of an evaluation pattern generation according to a first embodiment of the present invention;

FIG. 2 is a functional block diagram illustrating a configuration of an evaluation-pattern generating apparatus according to the first embodiment of the present invention;

FIG. 3 is a block diagram illustrating a hardware configuration of the evaluation-pattern generating apparatus;

FIG. 4 is a flowchart of a procedure of an operation by the evaluation-pattern generating apparatus;

FIG. 5 is a schematic diagram of an example of an evaluation target cell;

FIG. 6 is a schematic diagram for explaining information to be set to the evaluation target cell;

FIG. 7A is a schematic diagram for explaining an OPE range when light is emitted from one point;

FIG. 7B is a schematic diagram for explaining the OPE range when light is emitted from a plurality of points;

FIG. 8A is a schematic diagram illustrating a relationship between a light source shape and a mutual intensity distribution when an effective light source shape is 0.3σ;

FIG. 8B is a schematic diagram illustrating a relationship between the light source shape and the mutual intensity distribution when the effective light source shape is 0.85σ;

FIG. 9 is a schematic diagram for explaining a method of setting the OPE range from an experiment;

FIG. 10 is a schematic diagram illustrating an integral domain for obtaining a transmission cross coefficient (TCC);

FIG. 11 is a schematic diagram for explaining a search algorithm in which a local search method and a full search method are combined;

FIG. 12 is a schematic diagram of an example of an evaluation pattern;

FIG. 13 is a schematic diagram of an example of an exposure apparatus;

FIG. 14A is a schematic diagram illustrating an abutting pattern arranged in the evaluation target cell;

FIG. 14B is a schematic diagram illustrating a C-shaped pattern arranged in the evaluation target cell;

FIG. 14C is a schematic diagram illustrating a surrounded pattern arranged in the evaluation target cell;

FIG. 14D is a schematic diagram illustrating an H-shaped pattern arranged in the evaluation target cell;

FIG. 14E is a schematic diagram illustrating a comb pattern arranged in the evaluation target cell;

FIG. 14F is a schematic diagram illustrating a crank pattern arranged in the evaluation target cell;

FIG. 15A is a schematic diagram for explaining a relationship between a cost function and a vector sum;

FIG. 15B is a schematic diagram for explaining a mask pattern generating method using an algorithm for maximizing the vector sum; and

FIG. 16 is a flowchart of a procedure of a layout verification for the evaluation target cell.

### DETAILED DESCRIPTION OF THE INVENTION

Exemplary embodiments of an evaluation pattern generating method, a computer program product, and a pattern verifying method according to the present invention will be explained below in detail with reference to the accompanying drawings. The present invention is not limited to the following embodiments.

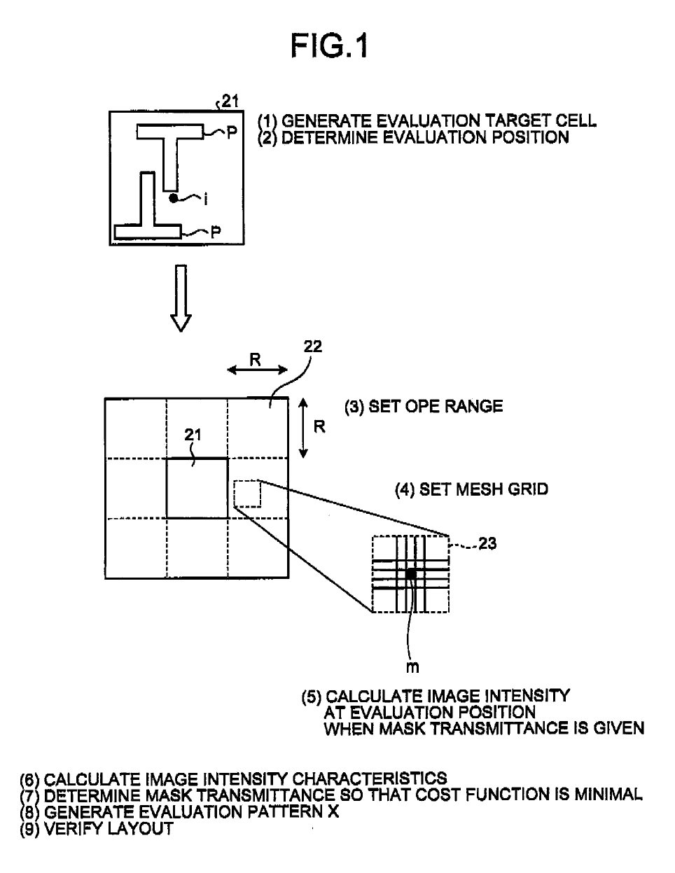

A concept of an evaluation pattern generation according to a first embodiment is explained. FIG. 1 is a schematic diagram for explaining the concept of the evaluation pattern generation according to the first embodiment of the present invention. A functional block pattern of a semiconductor circuit is realized, which is capable of maintaining a predetermined lithography performance with respect to a peripheral environment (a pattern) having various pattern variations. Therefore, a layout of a peripheral pattern (the worst peripheral pattern) that may fluctuate a transfer performance the most with respect to a hot spot of the layout of the functional block pattern is generated (prepared) as an evaluation pattern (a peripheral pattern for pattern verification) X. The functional block pattern is subjected to a lithography verification using the evaluation pattern X to verify stability of the functional block pattern to the peripheral environment. In the present embodiment, a method of generating an evaluation pattern for evaluating a pattern (a functional block) having a specific function is explained; however, the present embodiment is not limited thereto. The present embodiment can be applied to a method of generating an evaluation pattern for evaluating any circuit pattern.

First, a primitive cell (a standard cell) (hereinafter, “an evaluation target cell 21”) to be an evaluation target for the lithography performance is generated (1). The evaluation target cell 21 is a functional block and includes patterns P having various shapes. Furthermore, a position (hereinafter, “an evaluation position i”) to be an evaluation target for the lithography performance is determined in the evaluation target cell 21 (2).

Thereafter, a apparatus (hereinafter, “an evaluation-pattern generating apparatus 10”) that generates a peripheral pattern (the evaluation pattern X) to be arranged around the evaluation target cell 21 when verifying the lithography performance of the evaluation target cell 21 starts generating the evaluation pattern X.

The evaluation-pattern generating apparatus 10 sets a range (hereinafter, “an OPE range 22”), which has an effect on the evaluation target cell 21 by the OPE, on the periphery of the evaluation target cell 21 (3). The OPE range 22 is an annular area surrounding the periphery of the evaluation target cell 21, specifically, an area obtained by extending the evaluation target cell 21 in vertical and horizontal directions by a predetermined length (hereinafter, “an OPE length R”). The OPE range 22 is an area of the evaluation pattern X. The OPE length R is a length that has an effect on the evaluation target cell 21 by the OPE. Therefore, each of a vertical side and a horizontal side of the periphery of the OPE range 22 is longer than that of the evaluation target cell 21 by 2R. The evaluation-pattern generating apparatus 10 sets a mesh grid 23 having a predetermined mesh size in the OPE range 22 (4).

Next, the evaluation-pattern generating apparatus 10 calculates image intensity (light intensity) at the evaluation position i when each mesh (pixel) is given a mask transmittance (5). Furthermore, the evaluation-pattern generating apparatus 10 calculates image intensity characteristics for each of various focus values that are preset (6). At this time, the image intensity characteristics are calculated, for example, using a normalized image log slope (NILS) or a focus sensitivity at the evaluation position i. The evaluation-pattern generating apparatus 10 then evaluates a cost function based on the calculated image intensity characteristics. The cost function is defined by a degree of risk of occurrence of a hot spot in the functional block pattern that is evaluated based on the image intensity characteristics. For example, the cost function is defined so that the cost function becomes smaller as the risk of occurrence of a hot spot in the functional block pattern becomes higher.

The evaluation-pattern generating apparatus 10 determines a mask transmittance distribution in the mesh grid 23 so that the calculated cost function satisfies a predetermined reference (for example, the NILS becomes minimal or the focus sensitivity becomes maximum). This process is not necessarily performed for all meshes in the mesh grid 23. If the mask transmittance for all meshes can be obtained by calculating the mask transmittance of a certain mesh area, it is sufficient to perform the above process (the process of determining the mask transmittance distribution) for the certain mesh area. For example, if an optical system to be processed and a layout of the functional block pattern each have a spatial symmetry, it is expected that the mask transmittance in the mesh grid 23 also has a spatial symmetry corresponding thereto. Therefore, the mask transmittance of all meshes can be obtained by calculating the mask transmittance of a certain mesh area.

At this time, the evaluation-pattern generating apparatus 10 determines the mask transmittance of each mesh of the evaluation pattern so that the possibility of occurrence of a hot spot in the functional block pattern increases with reference to the cost function of the image intensity characteristics defined above (7). For example, when the cost function is defined so that the cost function becomes smaller as the possibility of occurrence of a hot spot becomes higher, the mask transmittance of each mesh of the evaluation pattern can be determined so that the cost function becomes minimal. The evaluation-pattern generating apparatus 10 employs the pattern corresponding to the determined mask transmittance as the evaluation pattern X and generates the evaluation pattern X (8). Thereafter, a layout verifying apparatus performs a layout verification of the lithography performance of the evaluation target cell 21 by using the evaluation pattern X (9).

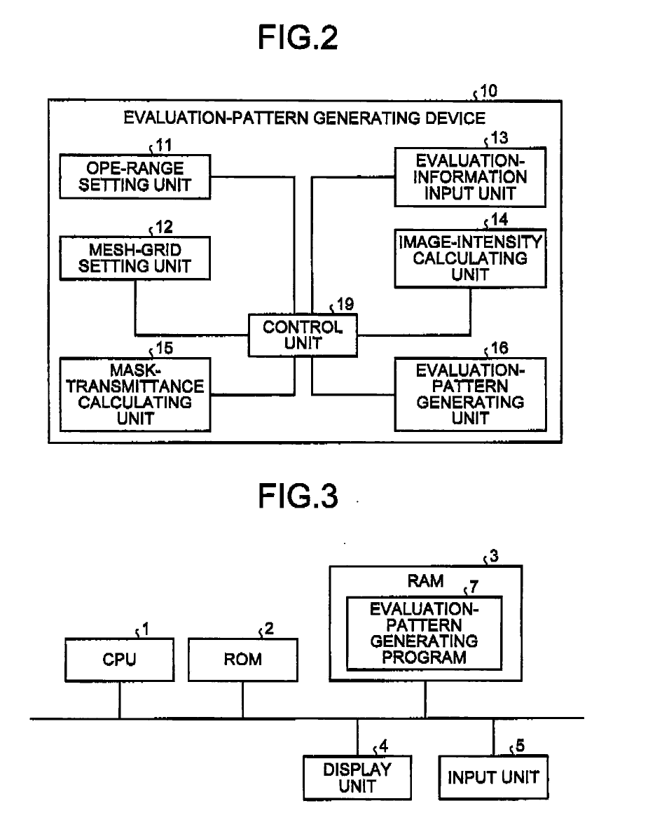

FIG. 2 is a functional block diagram illustrating a configuration of the evaluation-pattern generating apparatus 10. The evaluation-pattern generating apparatus 10 includes an OPE-range setting unit 11, a mesh-grid setting unit 12, an evaluation-information input unit 13, an image-intensity calculating unit 14, a mask-transmittance calculating unit 15, an evaluation-pattern generating unit 16, and a control unit 19.

The evaluation-information input unit 13 inputs information about the evaluation target cell 21 and the evaluation position i, and sends them to the OPE-range setting unit 11. The evaluation target cell 21 is generated by, for example, a mask data generating apparatus that generates mask data, and is sent to the evaluation-information input unit 13. The evaluation-information input unit 13 is connected to a mouse, a keyboard, and the like, and a user specifies the evaluation position i using the mouse or the keyboard.

The OPE-range setting unit 11 sets the OPE range 22 on the periphery of the evaluation target cell 21 based on information (exposure condition) of an exposure apparatus that performs an exposure process using a mask (hereinafter, “an evaluation target mask”) on which the evaluation target cell 21 is arranged. The OPE-range setting unit 11 sets the OPE range 22 based on, for example, an exposure wavelength (λ) of the exposure apparatus, a numerical aperture (NA) of a projection optical system, or an effective light source shape (σ). The OPE-range setting unit 11 sends the set OPE range 22 to the mesh-grid setting unit 12.

The mesh-grid setting unit 12 sets the mesh grid 23 corresponding to a limiting resolution (a design rule) of the exposure process used for the evaluation target mask to the OPE range 22. The mesh-grid setting unit 12 sends the OPE range 22 and the set mesh grid 23 to the image-intensity calculating unit 14.

The image-intensity calculating unit 14 calculates the image intensity at the evaluation position i for each mesh in a case of giving a mask transmittance to each mesh in the mesh grid 23. The image-intensity calculating unit 14 calculates for each mesh the image intensity characteristics (image intensity for each focus value) by using an optical image characteristic amount such as the NILS and the focus sensitivity for each of various focus values that are preset. The image-intensity calculating unit 14 sends the calculated image intensity characteristics for each mesh to the mask-transmittance calculating unit 15.

The mask-transmittance calculating unit 15 determines the mask transmittance for each mesh so that the cost function of the image intensity characteristics becomes minimal to obtain the mask transmittance distribution in the mesh grid 23. The mask-transmittance calculating unit 15 sends the distribution of the calculated mask transmittance to the evaluation-pattern generating unit 16.

The evaluation-pattern generating unit 16 generates a pattern corresponding to the mask transmittance as the evaluation pattern X. The control unit 19 controls the OPE-range setting unit 11, the mesh-grid setting unit 12, the evaluation-information input unit 13, the image-intensity calculating unit 14, the mask-transmittance calculating unit 15, and the evaluation-pattern generating unit 16.

FIG. 3 is a block diagram illustrating a hardware configuration of the evaluation-pattern generating apparatus 10 according to the first embodiment. The evaluation-pattern generating apparatus 10 includes a central processing unit (CPU) 1, a read only memory (ROM) 2, a random access memory (RAM) 3, a display unit 4, and an input unit 5. In the evaluation-pattern generating apparatus 10, the CPU 1, the ROM 2, the RAM 3, the display unit 4, and the input unit 5 are connected with each other via a bus line.

The CPU 1 generates the evaluation pattern X by using an evaluation pattern generating program 7 that is a computer program for generating the evaluation pattern X. The display unit 4 is a display device such as a liquid crystal monitor, and displays the evaluation pattern X or various information, such as the evaluation target cell 21, the evaluation position i, the OPE range 22, and the mesh grid 23, that is used when generating the evaluation pattern X, based on an instruction from the CPU 1. The input unit 5 includes a mouse and a keyboard, and inputs instruction information, such as an instruction of specifying the evaluation position i and parameters needed for generating the evaluation pattern, that is input from an external device by a user. The instruction information input to the input unit 5 is sent to the CPU 1.

The evaluation-pattern generating program 7 is stored in the ROM 2, and is loaded to the RAM 3 via the bus line. The CPU 1 executes the evaluation-pattern generating program 7 loaded in the RAM 3. Specifically, in the evaluation-pattern generating apparatus 10, the CPU 1 reads the evaluation pattern generating program 7 from the ROM 2 in accordance with the instruction input by a user via the input unit 5 and loads it to a program storing area in the RAM 3 to execute various processes. The CPU 1 stores various data generated in the various processes temporarily in the data storing area formed in the RAM 3.

The evaluation-pattern generating program 7 executed in the evaluation-pattern generating apparatus 10 has a module structure including the above units, i.e., the OPE-range setting unit 11, the mesh-grid setting unit 12, the evaluation-information input unit 13, the image-intensity calculating unit 14, the mask-transmittance calculating unit 15, the evaluation-pattern generating unit 16, and the control unit 19. Each unit is loaded on a main storage device, and thereby the OPE-range setting unit 11, the mesh-grid setting unit 12, the evaluation-information input unit 13, the image-intensity calculating unit 14, the mask-transmittance calculating unit 15, the evaluation-pattern generating unit 16, and the control unit 19 are generated on the main storage device.

The evaluation-pattern generating program 7 executed in the evaluation-pattern generating apparatus 10 can be provided in such a way that the evaluation-pattern generating program 7 is stored in a computer connected to a network such as the Internet and is downloaded via the network. The evaluation-pattern generating program 7 executed in the evaluation-pattern generating apparatus 10 can also be provided or distributed via the network such as the Internet. Alternatively, the evaluation-pattern generating program 7 can be embedded in a ROM or the like in advance and provided to the evaluation-pattern generating apparatus 10.

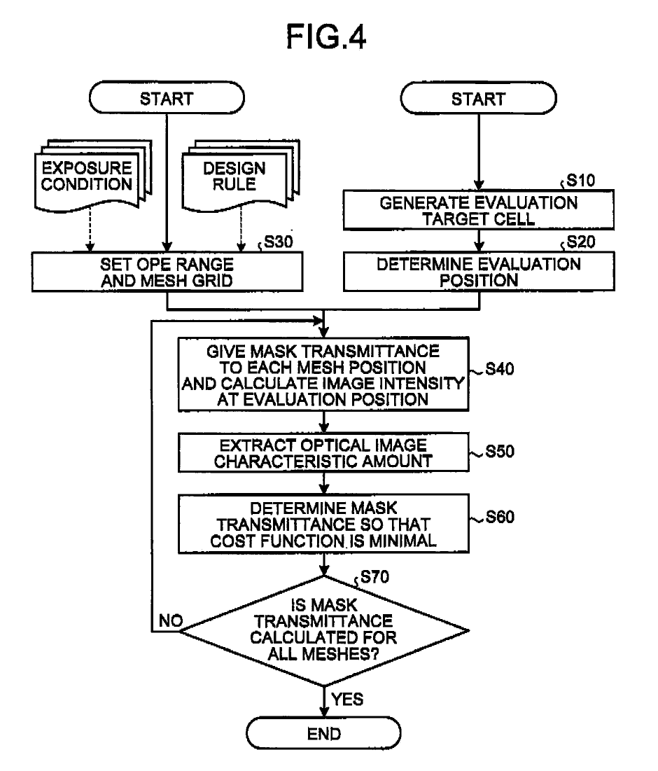

The procedure of the operation by the evaluation-pattern generating apparatus 10 is explained. FIG. 4 is a flowchart of the procedure of the operation by the evaluation-pattern generating apparatus 10. First, the evaluation target cell 21 is generated, and the evaluation position i is determined (Steps S10 and S20). At this time, a user specifies the evaluation position i in units of pixel. The evaluation target cell 21 and the evaluation position i are input to the evaluation-information input unit 13. The evaluation-information input unit 13 sends the evaluation target cell 21 and the evaluation position i to the OPE-range setting unit 11.

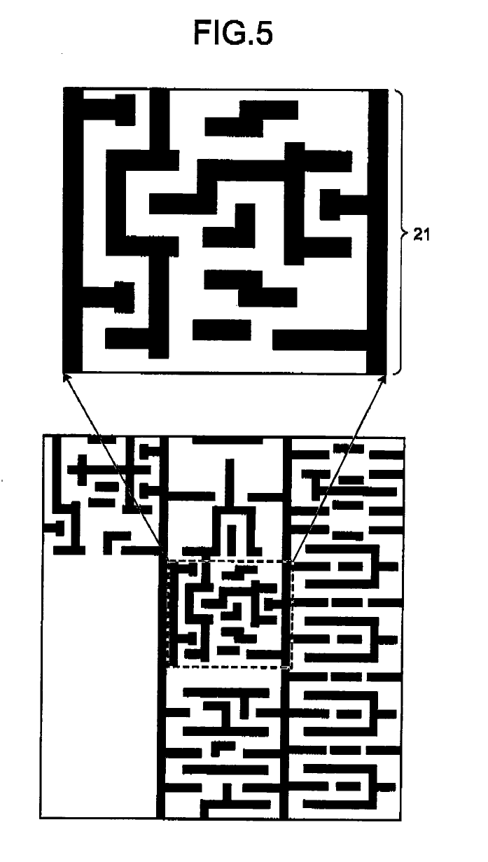

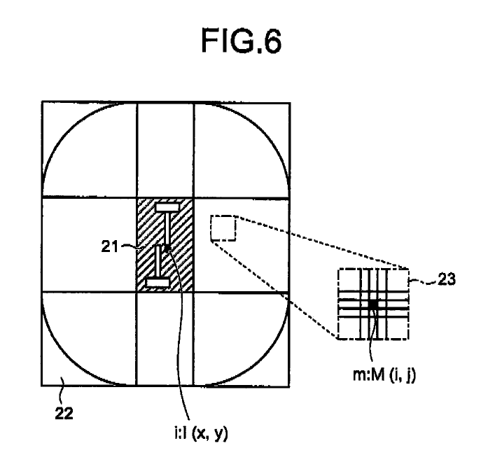

FIG. 5 is a schematic diagram of an example of the evaluation target cell 21, and FIG. 6 is a schematic diagram for explaining information to be set to the evaluation target cell 21. As shown in FIG. 5, the evaluation target cell 21 has various line patterns in the vertical and horizontal directions, and the line patterns are arranged so that adjacent line patterns have a predetermined distance from each other.

As shown in FIG. 6, the OPE-range setting unit 11 sets a predetermined position that is specified as the evaluation point by a user as the evaluation position i. The image intensity at the evaluation position i is expressed by I(x, y), and a mask transmittance distribution at the mesh position m is expressed by M(i,j).

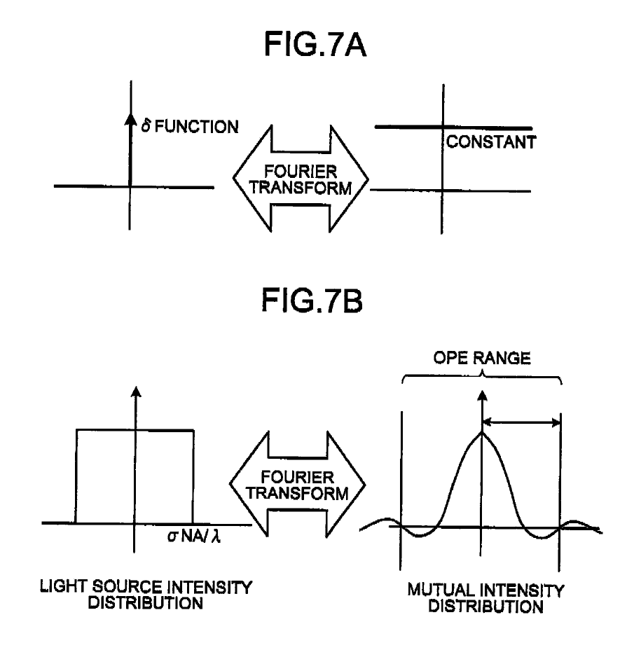

FIGS. 7A and 7B are schematic diagrams for explaining the OPE range 22. In FIGS. 7A and 7B, graphs on the left side show a light intensity distribution, in which a vertical axis represents light intensity and a horizontal axis represents a size of a light source. Moreover, in FIGS. 7A and 7B, graphs on the right side show a mutual intensity distribution obtained by performing the Fourier transform on the light intensity distribution, in which a vertical axis represents mutual intensity and a horizontal axis represents space coordinates on a wafer.

As shown in FIGS. 7A and 7B, the OPE range 22 correlates strongly with the exposure wavelength (λ) of the exposure apparatus, the numerical aperture (NA) of the projection optical system, and the effective light source shape (σ). Therefore, the OPE-range setting unit 11 sets the OPE range 22 based on exposure conditions of the exposure apparatus, such as the exposure wavelength, the numerical aperture of the projection optical system, and the effective light source shape.

The OPE range in a partially coherent optical system that is employed as an optical system of a typical exposure apparatus is defined by mutual intensity between lights that pass two different points on a mask (a reticle). According to the van Cittert-Zernike theorem, the mutual intensity is expressed as a result of the Fourier transform of a distribution of the light source that irradiates the mask, so that the OPE range largely depends on the effective light source shape (σ) of the exposure apparatus.

For example, as shown in FIG. 7A, when light is emitted from one point, a Fourier pattern distribution representing the OPE range is constant regardless of the mutual intensity distribution. As shown in FIG. 7B, when light is emitted from a plurality of points, the Fourier pattern distribution representing the OPE range is represented by a predetermined waveform. When the area of the light source is large, the Fourier pattern distribution is localized, whereas when the area of the light source is small, the Fourier pattern distribution becomes spread out.

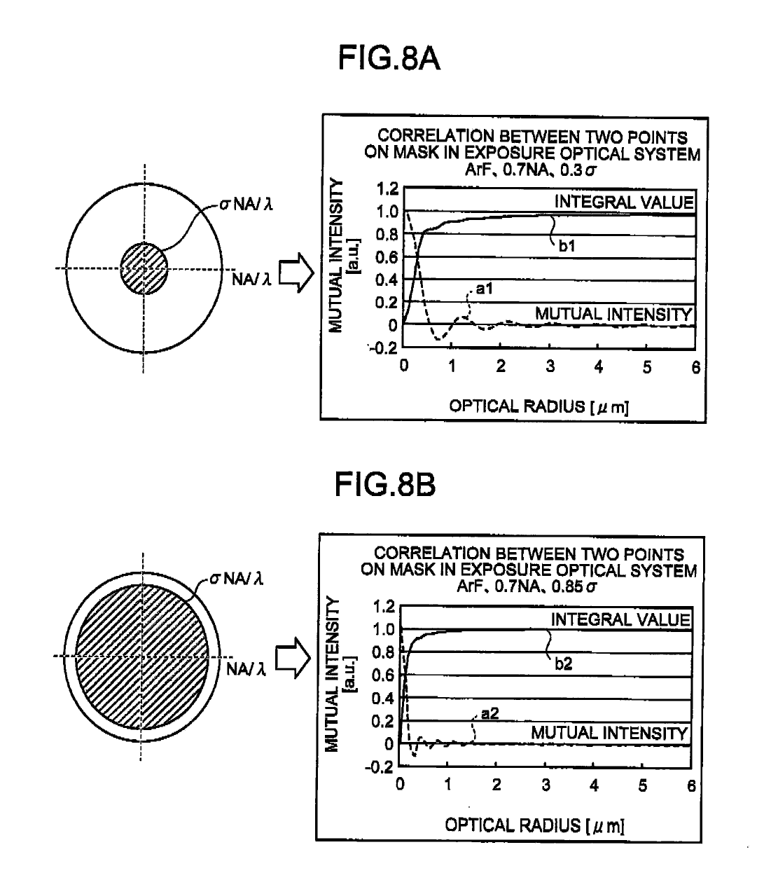

FIGS. 8A and 8B are schematic diagrams each illustrating a relationship between the light source shape and the mutual intensity distribution. In FIGS. 8A and 8B, diagrams on the left side show the light source shape (an illumination shape), and diagrams on the right side show a change in mutual intensity of the light source with respect to an optical radius (correlation between two points on a mask in an exposure optical system). Moreover, in FIGS. 8A and 8B, dashed-line curves represent mutual intensity a1 and a2 obtained by performing the Fourier transform on σNA/λ, and solid-line curves represent integral values (mutual intensity b1 and b2) obtained by integrating the mutual intensity a1 and a2.

FIG. 8A shows a case in which the light source is ArF, the NA of the projection optical system is 0.7 NA, and the effective light source shape is 0.3σ, and FIG. 8B shows a case in which the light source is ArF, the NA of the projection optical system is 0.7 NA, and the effective light source shape is 0.85σ. Therefore, the optical shape shown in FIG. 8A is smaller than that shown in FIG. 8B. The optical radius with which the integral value becomes one is smaller in the case where the optical shape is large as shown in FIG. 8B than in the case where the optical shape is small as shown in FIG. 8A.

The light source shape and the mutual intensity distribution have a relationship, for example, as shown in FIGS. 8A and 8B, so that it is theoretically possible to set the range (an OPE distance R), which has an effect of the OPE, by a predetermined reference. When the optical shape is small, the optical radius when the integral value starts to become a constant value is large, so that the OPE distance R becomes large. When the optical shape is large, the optical radius when the integral value starts to become a constant value is small, so that the OPE distance R becomes small.

It is also possible, in an experiment, to prepare a plurality of patterns having different inter-pattern distances and set the OPE range 22 at the inter-pattern distance at the time when the pattern dimension after transfer starts to become a constant value.

FIG. 9 is a schematic diagram for explaining a method of setting the OPE range from an experiment. Line patterns L2 are arranged at various inter-pattern distances (spaces) away from a line pattern L1. A dimension of the line pattern L1 on the wafer in a line width direction is measured and plotted.

For example, the inter-pattern distance between the line pattern L1 and the line pattern L2 is increased in order of a distance S1, a distance S2, and a distance S3 (S1<S2<S3). At this time, the dimension of the line pattern L1 becomes a stable constant value when the inter-pattern distance between the line pattern L1 and the line pattern L2 becomes a predetermined value or more. FIG. 9 shows a case in which the dimension of the line pattern L1 becomes stable when the inter-pattern distance becomes the distance S3 or more. In such a case, the distance S3 can be set as the OPE distance R.

In determining the OPE distance R in the above manner, the OPE distance R is affected also by flare (stray light) of the optical system, a loading effect in a process such as developing, or the like. The OPE distance R can be determined considering or ignoring the above effects. A user of the evaluation-pattern generating apparatus 10 can determine whether to consider the flare (a flare effect range) of the optical system and the loading effect in accordance with the degree of the above effects.

Next, the mesh-grid setting unit 12 sets the mesh grid 23 corresponding to the limiting resolution of the exposure process used for the evaluation target mask to the OPE range 22 (Step S30).

Specifically, the mesh-grid setting unit 12 generates a mesh grid in the OPE range 22 set by the OPE-range setting unit 11. At this time, a mesh size of the mesh grid generated by the mesh-grid setting unit 12 is preferably set, for example, in accordance with the limiting resolution of the exposure process that is assumed to be used. If the mesh size is too large with respect to the limiting resolution, it becomes difficult to generate an appropriate pattern effect degree as the evaluation pattern. Therefore, the mesh size is preferably set to be at least equal to or smaller than the limiting resolution, more preferably, equal to or smaller than a minimal dimension in the design rule to be conformed when designing the functional block to be checked as the evaluation target pattern. If the mesh size is large, time required for generating the evaluation pattern can be shortened.

The mesh-grid setting unit 12 sends the OPE range 22 and the set mesh grid 23 to the image-intensity calculating unit 14. The image-intensity calculating unit 14 calculates the image intensity at the evaluation position i for each mesh in the case of giving the mask transmittance to each mesh in the mesh grid 23 (Step S40). Specifically, the image-intensity calculating unit 14 calculates the image intensity, for example, by using a partially coherent optical imaging expression as an image intensity calculating method. The partially coherent optical imaging expression can be expressed by Expression (1).

I(x,y)=f⁻¹{∫TCC(f+f′,g+g′;f′,g′)m(f+f′,g+g′)m*(f′,g′)df′dg′} (1)

where F{ } is the Fourier transform, F⁻¹ is the reverse Fourier transform, a transmission cross coefficient (TCC) is a mutual transmission coefficient expressed by Expression (2), (f, g) is coordinates (Fourier coordinates of the mask pattern) on the mask plane, and (X, Y) is coordinates on the wafer plane.

TCC(f,g;f′,g′)=∫S(f″,g″)P(f+f″,q+g″)P*(f′+f″,g′+g″)df″dg″ (2)

where S is an effective light source distribution, which is expressed by Expression (3) to Expression (5).
Specifically, when Expression (3) that is a coherence factor is satisfied, the effective light source distribution can be expressed by Expression (4), and when Expression (3) is not satisfied, the effective light source distribution can be expressed by Expression (5).

if \sqrt{f²+g²}≦σNA/λ (3)

S(f,g)=1 (4)

Else S(f,g)=0 (5)

Moreover, P in Expression (2) is a pupil function and can be expressed by Expression (6) to Expression (8). Specifically, when Expression (6) is satisfied, the pupil function can be expressed by Expression (7), and when Expression (6) is not satisfied, the pupil function can be expressed by Expression (8).

if \sqrt{f²+g²}≦NA/λ (6)

|P(f,g)|=1 (7)

Else P(f,g)=0 (8)

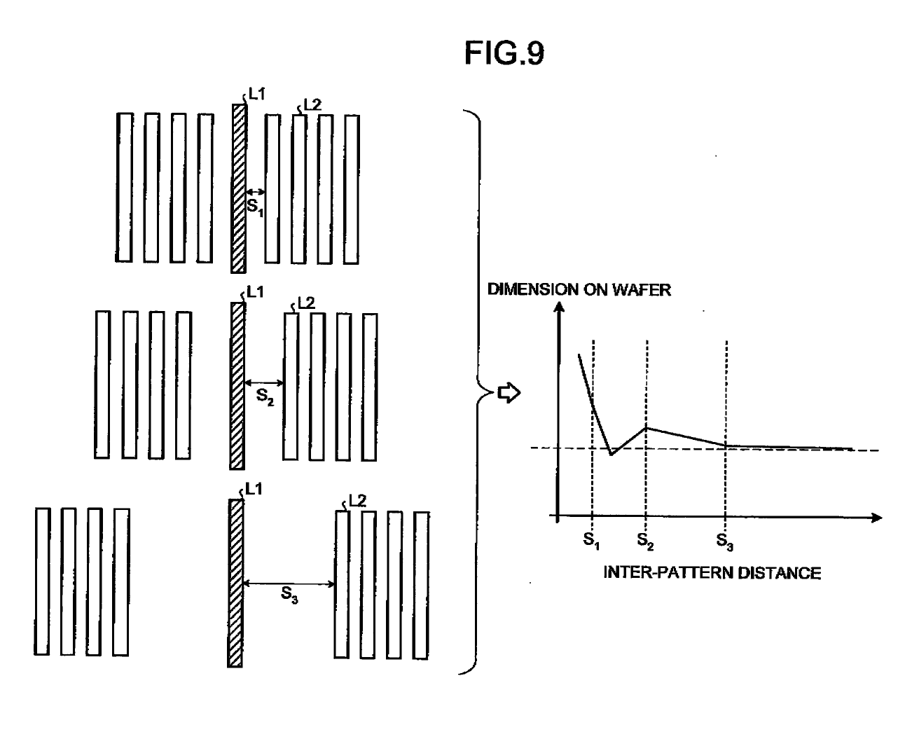

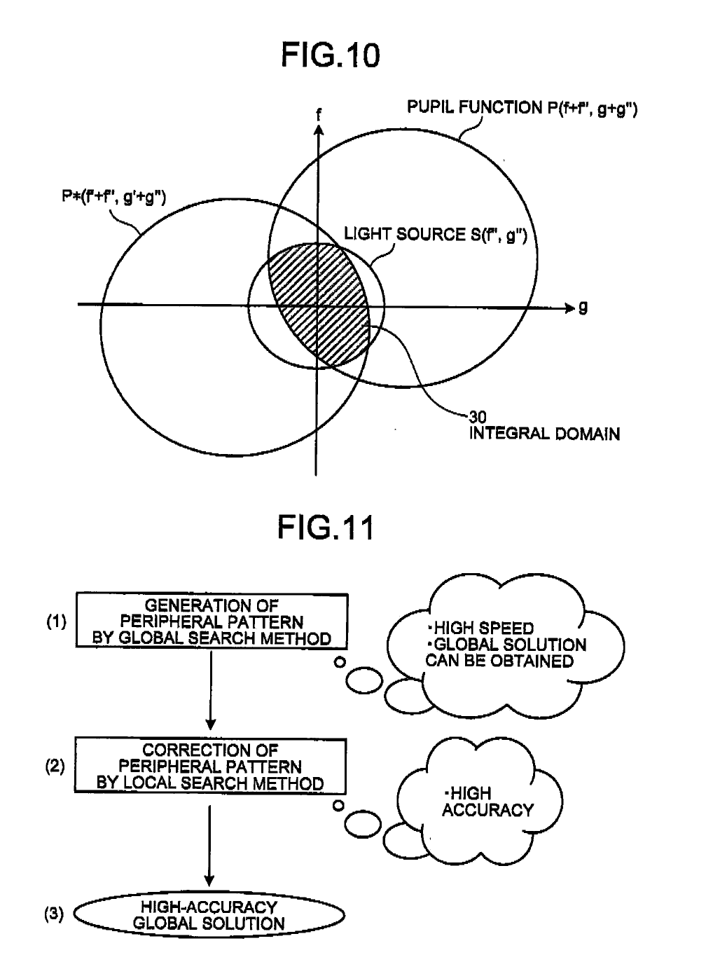

FIG. 10 is a schematic diagram illustrating an integral domain 30 for obtaining the TCC. An area (a shaded area) surrounded by S(f″, g″), P(f+f″, g+g″), and P*(f′+f″, g′+g″) is the integral domain 30.

The image intensity is calculated, for example, by using a diffracted light distribution F⁻¹{m(f, g)}=m(x, y) obtained by a mask pattern (m(f, g)). Expression (1) is expressed in a scalar form. However, when the exposure apparatus has high NA, the image intensity can be calculated by using an expression expanded to a vector imaging form. In this manner, the image intensity can be calculated by Expression (1) with high accuracy even with respect to the exact solution.

Moreover, for example, an expression obtained by an eigenvalue expansion according to the optical coherent approximation (OCA) method described in “Phase-shifting masks for microlithography: automated design and mask requirements” by Y. C. Pati et al. in Journal of Optical Society of America A/Vol. 11, No. 9/p 1.2438-2452/September (1994) can be used. The cost for calculation can be suppressed low by calculating the image intensity by using the above method. The imaging expression by the OCA is expressed by Expression (9).

$$I ( x , y ) \sim {\sum }_{k} {σ}_{k} {\vert {F}^{- 1} \{ {Φ}_{k} \cdot m ( f , g ) \} \vert}^{2} \qquad ( 9 )$$

where, Φₖ (k=0, 1, 2, . . . , N) (N is a natural number) is an eigenfunction kernel, and σₖ is an eigenvalue when the TCC is expanded with the eigenfunction kernel Φₖ.

A calculation TAT can be significantly improved by calculating the image intensity by using the OCA method. In the present embodiment, it is applicable to cause the evaluation-pattern generating apparatus 10 to calculate the image intensity by specifying any one of Expression (1) and Expression (9). The image-intensity calculating unit 14 calculates the image intensity characteristics (image intensity for each focus value) using the NILS or the focus sensitivity for each of various focus values that are preset. Specifically, the image intensity calculated by Expression (1) or Expression (9) is calculated for each of a plurality of focus values that are preset to obtain the image intensity characteristics for each focus value. The image intensity characteristics are calculated, for example, by using the NILS (wΔI/Δx) that is a normalized optical image log slope, the focus sensitivity (ΔI/ΔF), or the like. Therefore, the image-intensity calculating unit 14 extracts the optical image characteristic amount such as the NILS and the focus sensitivity in advance based on an instruction by a user or preset information (step S50). Then, the image-intensity calculating unit 14 sets the extracted optical image characteristic amount to the image intensity characteristics for each focus value to calculate the image intensity characteristics.

The image-intensity calculating unit 14 sends the calculated image intensity characteristics to the mask-transmittance calculating unit 15. The mask-transmittance calculating unit 15 determines the mask transmittance so that the cost function of the image intensity characteristics becomes minimal (Step S60). The evaluation-pattern generating apparatus 10 checks whether the mask transmittance is calculated for all the meshes (Step S70).

If the mask transmittance is calculated not for all the meshes (No at Step S70), the processes from Step S40 to Step S60 are repeated so that the evaluation-pattern generating apparatus 10 calculates the mask transmittance for the next mesh. The evaluation-pattern generating apparatus 10 repeats the processes from Step S40 to Step S70 until the mask transmittance distribution is obtained by calculating the mask transmittance of all the masks to obtain the distribution of M(i,j) as the mask transmittance distribution in the mesh grid 23. The mask-transmittance calculating unit 15 sends the calculated mask transmittance distribution to the evaluation-pattern generating unit 16.

A method of obtaining the distribution of M(i,j) is explained. When calculating the distribution of M(i,j) using the NILS, the mask-transmittance calculating unit 15 calculates the distribution of M(i,j) so that the NILS is minimal. When calculating the distribution of M(i,j) using the focus sensitivity, the mask-transmittance calculating unit 15 calculates the distribution of M(i,j) so that the focus sensitivity is maximum.

For example, if M(i,j) is calculated by random search, it may take a long time to obtain the evaluation pattern X (a verification pattern). Therefore, M(i,j) can be efficiently calculated in a shorter time by using the following algorithm.

For example, as a local search method of M(i,j), an inverse lithography technology (ILT) disclosed in U.S. Pat. No. 7,178,127 B2 (2007) “METHOD FOR TIME-EVOLVING RECTILINEAR CONTOURS REPRESENTING PHOTO MASKS” by Abrams et al. or an algorithm such as a genetic algorithm and a simulated annealing is used, so that the convergence to a solution can be accelerated.

A local search solution obtained by using a sequential correction method has characteristics that the solution depends on the initial condition, which is inevitable. Therefore, the initial condition of M(i, j) needs to be set carefully by an empirical method or an analytical method.

Moreover, by using an interference mapping lithography (IML) described in “Contact Hole Reticle Optimization by Using Interference Mapping Lithography (IML™)”, Proc. SPIE 5377 (2004), pp. 222-pp. 240, by R. Socha et al. as a full search method of M(i, j), an inverse solution M(i, j) can be obtained in an extremely short time without using the sequential correction method.

Furthermore, a search algorithm in which the local search method and the full search method are combined can be used, thereby enabling to calculate a high-accuracy full search solution at high speed. FIG. 11 is a schematic diagram for explaining the search algorithm in which the local search method and the full search method are combined. First, the image-intensity calculating unit 14 calculates at least one global approximate solution by the full search method (a global search method) to generate a peripheral pattern. The image-intensity calculating unit 14 can obtain a global solution at high speed by the full search method (1).

Next, the image-intensity calculating unit 14 generates a peripheral pattern by using the local search method with the approximate solution obtained by the full search method as the initial condition. The image-intensity calculating unit 14 can improve the accuracy of the solution by the local search method (2). The image-intensity calculating unit 14 can obtain a high-accuracy global solution (the evaluation pattern X) by the processes (1) and (2) (3). Moreover, a pattern that is close to a solution to be obtained is given in advance as the initial condition in the local search method, so that the convergence to the solution to be obtained is improved, enabling to reduce the cost.

At this time, the image-intensity calculating unit 14 calculates M(i, j), for example, by using Expression (10) as a const function (an evaluation function) F.

F=ΣA*NILS(i,j)+B/Focus Sensityvity(i,j) (10)

where, A and B are each appropriate constant.

The optical image intensity at a position on a wafer at which shortening may occur, such as a corner or an edge of patterns that constitute the evaluation target cell 21, can be selected as the cost function. The cost function F at this time can be expressed by Expression (11-1). Alternatively, the cost function F can be defined by Expression (11-2).

F=Intensity(i,j) (11-1)

F=\sqrt{Intensity(i,j)}=|∫dxdym(x,y)f²(x,y)| (11-2)

The mask-transmittance calculating unit 15 sends the determined mask transmittance distribution M(i, j) to the evaluation-pattern generating unit 16. The evaluation-pattern generating unit 16 generates a pattern corresponding to the mask transmittance as the evaluation pattern X. Whereby, M(i, j) is employed as the evaluation pattern X with respect to the evaluation target cell 21. Then, when verifying the evaluation target cell 21 by the LCC, the evaluation pattern X is arranged on the periphery of the evaluation target cell 21 and a hot spot is checked to perform a layout verification of the evaluation target cell 21.

When performing the layout verification of the evaluation target cell 21, a focus dependence or a dose dependence (NILS) becomes maximum at the evaluation position i by the influence of the evaluation pattern X, so that a process margin at the evaluation position i is expected to be minimal. It is possible to design a layout of a robust functional block pattern capable of ensuring a process margin independent from the peripheral environment by designing the pattern layout (the evaluation target cell 21) that can pass the layout verification even when performing such layout verification. In other words, a functional block pattern having a stable layout pattern can be provided even when the peripheral environment is not good.

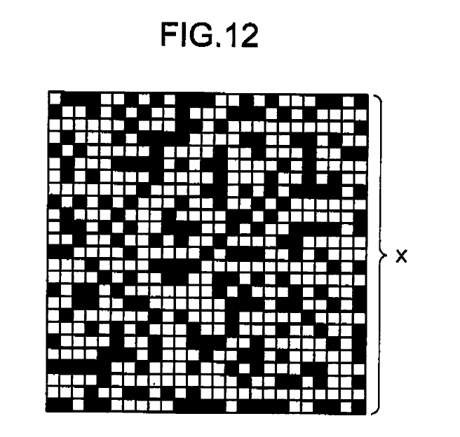

FIG. 12 is a schematic diagram of an example of the evaluation pattern. As shown in FIG. 12, in the present embodiment, the evaluation pattern X is divided by the mesh grid 23 and a pattern corresponding to the mask transmittance distribution (the mask transmittance for each mesh) is generated as the evaluation pattern X. The evaluation pattern X is a cell in which whether a pattern is present or not is set with respect to each of areas (meshes) divided in a meshed manner. The mask transmittance distribution is a distribution that fluctuates the transfer performance the most with respect to a hot spot of the functional block pattern.

After the layout verification is performed, a mask pattern is generated by using the evaluation target cell 21 that has passed the layout verification, and thereafter a mask is produced. The exposure apparatus performs the exposure process on a wafer by using the produced mask to produce a semiconductor device.

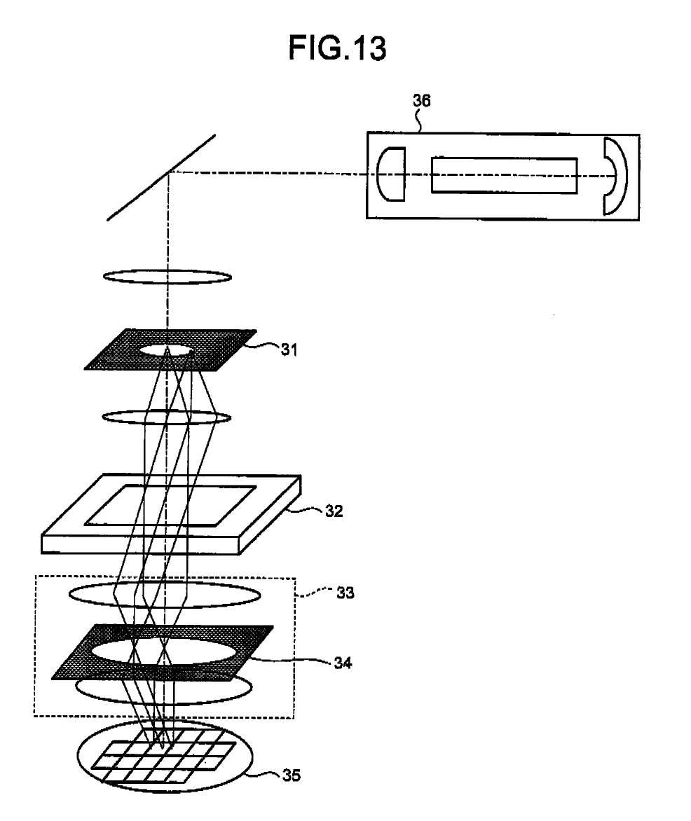

FIG. 13 is a schematic diagram of an example of the exposure apparatus. The exposure apparatus includes a light source 36, a σ aperture 31, and a projection optical system 33. A mask 32 (a photomask on which the evaluation target cell 21 is arranged) is irradiated with exposure light emitted from the light source 36 through the aperture 31. Only part of the exposure light that corresponds to the mask pattern transmits through the mask 32 to reach the projection optical system 33. The projection optical system 33 includes an NA aperture 34 and a lens, and irradiates a wafer 35 with the exposure light from the mask 32.

In FIG. 6, one evaluation position i is arranged in the evaluation target cell 21; however, a plurality of the evaluation positions i can be arranged if necessary. In the present embodiment, explanation is given for a case in which the evaluation pattern X to generate an extreme value of the optical image characteristic amount such as the NILS and the focus sensitivity is generated; however, a plurality of the evaluation patterns X each having a sensitivity exceeding a preset reference value of the optical image characteristic amount can be generated.

In the present embodiment, explanation is given for a case in which the optical image characteristic amount is the NILS or the focus sensitivity; however, the optical image characteristic amount is not limited thereto. The optical image characteristic amount can be a tilt of an optical image or an optical image intensity. The cost function is not limited to the optical image characteristic amount at the evaluation position i and can be defined by using a pattern dimension (for example, a gate width) in the evaluation target cell 21 or the like.

Moreover, in the present embodiment, the evaluation pattern X is obtained by combining the local search method and the full search method; however, the evaluation pattern X can be obtained by combining two or all of the local search method, the full search method, and the empirical method.

Furthermore, when performing the OPC on the evaluation target cell 21, the OPC can be performed for each evaluation pattern X. In this case, it is preferable that the evaluation pattern X be excluded from the target for the OPC and be referred to as a peripheral pattern when performing the OPC.

According to the first embodiment, the peripheral portion of the evaluation target cell 21 is divided in a meshed manner, and the transmittance of each mesh is determined based on the image intensity at the evaluation position i to generate the evaluation pattern X, so that the peripheral pattern (the evaluation pattern X capable of verifying stability sufficient with respect to the peripheral environment of the pattern layout) that fluctuates the transfer performance the most with respect to a hot spot can be generated easily in a short time.

The “mask transmittance” in the present embodiment can be replaced by a “mask reflectivity” when the lithography process is adapted to an extreme ultraviolet (EUV) lithography. In the present embodiment, the concept of including the mask transmittance and the mask reflectivity is defined as the mask function value in the present embodiment. The mask transmittance in the present embodiment can be generally replaced by a term “mask function value”.

In the present embodiment, explanation is given for a case in which the layout data of the evaluation pattern X is generated with respect to the layout (the evaluation target cell 21) of the functional block pattern; however, a mask pattern of the evaluation pattern can be generated with respect to the mask pattern corresponding to the functional block pattern. In this case, the evaluation-pattern generating apparatus 10 sets the OPE range 22 on the periphery of the evaluation target mask pattern to generate the evaluation pattern (a mask pattern) based on the information of the exposure apparatus that performs the exposure process by using the evaluation target mask on which a mask pattern (an evaluation target mask pattern) corresponding to the evaluation target cell 21 is formed.

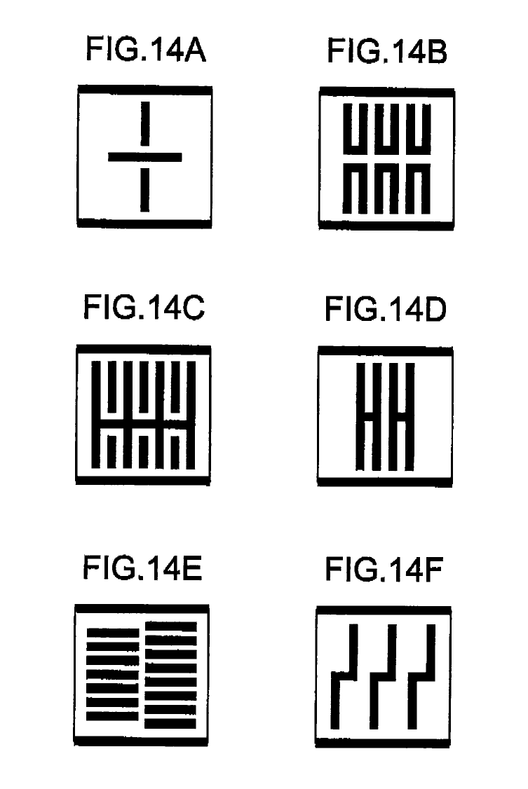

A second embodiment is explained with reference to FIGS. 14A to 14F. In the first embodiment, the evaluation pattern X (a peripheral environment pattern) that lowers the process margin of the evaluation target cell 21 is analytically calculated. In the second embodiment, the cost function is made to a function that can perform calculation linearly with respect to the mask transmittance. Specifically, the summation (a component proportional to the optical image intensity) of square roots of the optical image intensity at a plurality of points on a wafer is chosen as the cost function. Whereby, the optical image intensity is linearly approximated to the mask transmittance. The optical image intensity is calculated by using a direct product vector of electrical fields of light waves that are emitted from respective light sources, which are incoherent with each other, and reach respective points on the wafer.

First, a position at which a short circuit or breaking easily occurs is set to the evaluation position i. Then, the optical image intensity at the evaluation position i at which a short circuit or breaking easily occurs is taken as the cost function. The position at which a short circuit or breaking easily occurs is explained. The position at which a short circuit or breaking easily occurs differs depending on a type of a pattern arranged in the evaluation target cell 21. FIGS. 14A to 14F are schematic diagrams for explaining the types of the pattern arranged in the evaluation target cell 21.

The pattern arranged in the evaluation target cell 21 includes an abutting pattern as shown in FIG. 14A, a C-shaped pattern as shown in FIG. 14B, a surrounded pattern as shown in FIG. 14C, an H-shaped pattern as shown in FIG. 14D, a comb pattern as shown in FIG. 14E, and a crank pattern as shown in FIG. 14F.

The abutting pattern is such that a first line pattern (a line extending in a lateral direction) and a second line pattern (a line extending in a longitudinal direction) are arranged at a right angle to form a T shape and a predetermined space is provided between the first line pattern and the second line pattern. Specifically, the second line pattern is arranged such that the second line pattern abuts a middle portion of the first line pattern when the second line pattern is extended on the first line pattern side.

The C-shaped pattern is a pattern in which a plurality of C-shaped patterns is arranged. The surrounded pattern is a pattern in which line patterns are each surrounded in three directions by a C-shaped pattern. The H-shaped pattern is a pattern in which a plurality of H-shaped patterns is arranged. The comb pattern includes two comb patterns that are arranged such that the teeth of one of the comb patterns face the spaces between teeth of the other of the comb patterns. The crank pattern is a pattern in which a plurality of crank patterns is arranged.

For example, in the abutting pattern, the position (an abutting part) between the first line pattern and the second line pattern is easy to cause a short circuit due to defocusing or the like in the exposure process compared with other positions. In the surrounded pattern, the position (the abutting part) between an edge of the line pattern and a bottom part of the C-shaped pattern is easy to cause a short circuit due to defocusing or the like in the exposure process compared with other positions. In this manner, each type of the patterns has a position at which a short circuit or breaking is easy to occur. Thus, in the present embodiment, the position at which a short circuit or breaking is easy to occur is set as the evaluation position i.

In the following explanation, as an example of generating the evaluation pattern X, the evaluation pattern X is generated with respect to the abutting pattern. In the abutting pattern, the abutting part causes a short circuit as the optical image intensity at the abutting part increases. Thus, in the present embodiment, the abutting part is set as the evaluation position i, the optical image intensity at the evaluation position i is taken as the cost function, and the evaluation pattern X is generated.

The procedure of the operation of the evaluation-pattern generating apparatus 10 according to the second embodiment is explained. The processes same as those in the first embodiment are not explained here. The evaluation target cell 21 and the evaluation position i are input to the evaluation-information input unit 13 of the evaluation-pattern generating apparatus 10 in advance. The evaluation position i is the abutting part of the abutting pattern.

The evaluation-pattern generating apparatus 10 divides the evaluation target mask into P×Q meshes and the evaluation pattern X is calculated in units of pixel. An electrical field of a light wave is denoted as Eₛ(p, q, x, y). The light wave is a wave of the light that is emitted from a light source s (s=1, 2, . . . , S) of S number of light sources that are incoherent with each other, is diffracted by a mask element (p, q) (p=1, 2, . . . , P, q=1, 2, . . . Q), and reaches wafer coordinates (x, y). The electrical field is linear with respect to the mask transmittance.

A mask function m(p, q) is defined as a transmittance of the mask element (p, q). For example, in the case of a binary mask, m(p, q)=(0, 1). Next, a mask pattern K is defined as a combination of the mask elements (p, q) in units of pixel. The mask element (p, q) can be expressed by Expression (12).

$$m ( p , q ) = \{ \begin{matrix}1 & for ( p , q ) ∈ K \\ 0 & for ( p , q ) ∉ K\end{matrix} \qquad ( 12 )$$

When the mask pattern K is given, the image-intensity calculating unit 14 calculates optical image intensity I(x, y) at the wafer coordinates (x, y) by Expression (13).

$$I ( x , y ) = {\sum }_{s = 1}^{S} {\vert {\sum }_{( p , q ) ∈ K} m ( p , q ) {E}_{s} ( p , q , x , y ) \vert}^{2} \qquad ( 13 )$$

Explanation is given of a case in which the optical image intensity I(x, y) is calculated by using the electrical field; however, the electrical field can be replaced by a physical quantity that functions equivalent to the electrical field. For example, the optical image intensity I(x, y) can be calculated by using a magnetic field or a scalar wave function instead of the electrical field.

A direct product vector of the electrical fields Eₛ(p, q, x, y) (s=1, 2, . . . , S) is defined as Expression (14). The optical image intensity I(x, y) at this time can be expressed by Expression (15).

$$\begin{matrix}\tilde{E} ( p , q , x , y ) = {E}_{1} ( p , q , x , y ) ⊗ {E}_{2} ( p , q , x , y ) ⊗ … ⊗ {E}_{s} ( p , q , x , y ) \\ = ( \begin{matrix}{E}_{1} ( p , q , x , y ) \\ {E}_{2} ( p , q , x , y ) \\ ⋮ \\ {E}_{s} ( p , q , x , y )\end{matrix} ) & ( 14 ) \\ I ( x , y ) = {\vert {\sum }_{( p , q ) ∈ K} m ( p , q ) \tilde{E} ( p , q , x , y ) \vert}^{2} & ( 15 )\end{matrix}$$

As shown in Expression (15), the square root (Expression (16)) of the optical image intensity is a linear function with respect to the mask function.

\sqrt{I(x,y)} (16)

As shown in Expression (15), it is found that the calculation for a mask pattern that maximizes the optical image intensity at the wafer coordinates (x, y) is the same as the calculation of a combination of (p, q) that maximizes the sum of vectors (Expression (17)) having a dimension proportional to S.

\tilde{E}(p,q,x,y) (17)

In the above explanation, the optical image intensity at one point on a wafer is taken as the cost function and the evaluation pattern X that maximizes the cost function is generated; however, it is possible that the summation of square roots of the optical image intensity at a plurality of positional coordinates (x₁, y₁), (x₂, y₂), . . . (x_{W}, y_{W}) on a wafer is taken as the cost function and the evaluation pattern X that maximizes the cost function is generated. In this case, a direct product vector (Expression (19)) of vectors expressed in Expression (18) is defined as Expression (20). At this time, the cost function is expressed by Expression (21) because the cost function has linearity with respect to the mask function.

$$\begin{matrix}\tilde{E} ( p , q , {x}_{1} , {y}_{1} ) , \tilde{E} ( p , q , {x}_{2} , {y}_{2} ) , … , \tilde{E} ( p , q , {x}_{w} , {y}_{w} ) & ( 18 ) \\ {E}^{\approx } ( p , q ) & ( 19 ) \\ {E}^{\approx } ( p , q ) = \tilde{E} ( p , q , {x}_{1} , {y}_{1} ) ⊗ \tilde{E} ( p , q , {x}_{2} , {y}_{2} ) ⊗ … ⊗ \tilde{E} ( p , q , {x}_{w} , {y}_{w} ) \\ = ( \begin{matrix}\tilde{E} ( p , q , {x}_{1} , {y}_{1} ) \\ \tilde{E} ( p , q , {x}_{2} , {y}_{2} ) \\ ⋮ \\ \tilde{E} ( p , q , {x}_{w} , {y}_{w} )\end{matrix} ) & ( 20 ) \\ \sqrt{I ( {x}_{1} , {y}_{1} )} + \sqrt{I ( {x}_{2} , {y}_{2} )} + … + \sqrt{I ( {x}_{w} , {y}_{w} )} = \vert {\sum }_{( p , q ) ∈ K} m ( p , q ) {E}^{\approx } ( p , q ) \vert & ( 21 )\end{matrix}$$

In the present embodiment, the mask pattern (the evaluation pattern X) of the peripheral environment pattern is generated under the condition that the pixels of the cell pattern portion (the evaluation target cell 21) are fixed; however, the evaluation pattern X can be generated with respect to an arbitrary evaluation target cell 21.

According to the second embodiment, the summation of square roots of the optical image intensity at a plurality of points on a wafer is chosen as the cost function and the optical image intensity is calculated by using a direct product vector of electrical fields of light waves that are emitted from light sources that are incoherent with each other and reach respective points on the wafer. Thus, the evaluation pattern X can be efficiently generated.

A third embodiment is explained. In the third embodiment, the summation of square roots of the optical image intensity at a plurality of points on a wafer is chosen as the cost function. The optical image intensity is calculated by using a direct product vector of terms of the optical image intensity after the Sum-Of-Coherent Systems (SOLS) expansion (OCA) at respective points on a wafer.

When spectral decomposition is performed on the TCC, the optical image intensity is expressed by Expression (22) as described in “Fast Optical and Process Proximity Correction Algorithms for Integrated Circuit Manufacturing” Ph.D. dissertation in UC Berkely (1998) by Nicolas Bailey Cobb.

$$I ( x , y ) = {\sum }_{k = 1}^{N} {λ}_{k} {\vert {\sum }_{( p , q ) ∈ K} m ( p , q ) {Φ}_{k} ( p - x , q - y ) \vert}^{2} \qquad ( 22 )$$

where, λₖ is a k-th eigenvalue, φₖ(f, g) is an eigenfunction, and Φₖ(x, y) is the Fourier transform of φₖ(f, g).

A direct product vector (Expression (23)) defined by a direct product of Φₖ(x, y) is expressed by Expression (24). At this time, the optical image intensity I(x, y) is expressed by Expression (25).

$$\begin{matrix}\tilde{Φ} ( p , q , x , y ) & ( 23 ) \\ \begin{matrix}\tilde{Φ} ( p , q , x , y ) = \sqrt{{λ}_{1}} {Φ}_{1} ( p - x , q - y ) ⊗ \sqrt{{λ}_{2}} \\ {Φ}_{2} ( p - x , q - y ) ⊗ … ⊗ \sqrt{{λ}_{N}} {Φ}_{N} ( p - x , q - y ) \\ = ( \begin{matrix}\sqrt{{λ}_{1}} {Φ}_{1} ( p - x , q - y ) \\ \sqrt{{λ}_{2}} {Φ}_{2} ( p - x , q - y ) \\ ⋮ \\ \sqrt{{λ}_{N}} {Φ}_{N} ( p - x , q - y )\end{matrix} )\end{matrix} & ( 24 ) \\ I ( x , y ) = {\vert {\sum }_{( p , q ) ∈ K} m ( p , q ) \tilde{Φ} ( p , q , x , y ) \vert}^{2} & ( 25 )\end{matrix}$$

In other words, the calculation of a mask pattern (the evaluation pattern X) that maximizes the optical image intensity at coordinates (x, y) on the wafer is the same as the calculation of a combination of (p, q) that maximizes the sum of vectors (Expression (23)) having a dimension proportional to N. The eigenvalue λₖ becomes zero rapidly as k increases in some cases depending on the illumination condition. In this case, the mask pattern is calculated ignoring a term of the eigenfunction having a small eigenvalue, enabling to calculate the mask pattern at high speed.

In the present embodiment, the mask pattern (the evaluation pattern X) of the peripheral environment pattern is generated under the condition that the pixels of the cell pattern portion (the evaluation target cell 21) are fixed; however, the evaluation pattern X can be generated with respect to an arbitrary evaluation target cell 21.

Moreover, in the present embodiment, explanation is given for a case in which the optical image intensity at one point is taken as the cost function and the evaluation pattern X that maximizes the cost function is generated; however, as in the second embodiment, the summation of square roots of the optical image intensity at a plurality of positional coordinates (x₁, y₁), (x₂, y₂), . . . , (x_{W}, y_{W}) on a wafer can be taken as the cost function and the evaluation pattern X that maximizes the cost function can be generated.

In this case, a direct product vector (Expression (27)) of vectors expressed by Expression (26) is defined as Expression (28). At this time, the cost function is expressed by Expression (29-1) because the cost function has linearity with respect to the mask function.

$$\begin{matrix}\tilde{Φ} ( p , q , {x}_{1} , {y}_{1} ) , \tilde{Φ} ( p , q , {x}_{2} , {y}_{2} ) , … , \tilde{Φ} ( p , q , {x}_{w} , {y}_{w} ) & ( 26 ) \\ {Φ}^{\approx } ( p , q ) & ( 27 ) \\ \begin{matrix}{Φ}^{\approx } ( p , q ) = \tilde{Φ} ( p , q , {x}_{1} , {y}_{1} ) ⊗ \tilde{Φ} ( p , q , {x}_{2} , {y}_{2} ) ⊗ … ⊗ \\ \tilde{Φ} ( p , q , {x}_{w} , {y}_{w} ) \\ = ( \begin{matrix}\tilde{Φ} ( p , q , {x}_{1} , {y}_{1} ) \\ \tilde{Φ} ( p , q , {x}_{2} , {y}_{2} ) \\ ⋮ \\ \tilde{Φ} ( p , q , {x}_{w} , {y}_{w} )\end{matrix} )\end{matrix} & ( 28 ) \\ \sqrt{I ( {x}_{1} , {y}_{1} )} + \sqrt{I ( {x}_{2} , {y}_{2} )} + … + \sqrt{I ( {x}_{w} , {y}_{w} )} = \vert {\sum }_{( p , q ) ∈ K} m ( p , q ) {Φ}^{\approx } ( p , q ) \vert & ( 29 \text{-} 1 )\end{matrix}$$

In the second and third embodiments, the cost function has linearity with respect to the mask function; however, the cost function can be a function approximate to a function that has linearity with respect to the mask function. That is, when evaluating the image intensity expressed by Expression (22), it is possible to use an approximate expression (Expression (29-2)) according to an Optimal Coherent Assumption (OCA) method described in “Phase-shifting masks for microlithography: automated design and mask requirements” by Y. C. Pati et al. in Journal of Optical Society of America A/Vol. 11, No. 9/p 1.2438-2452/September (1994). In Expression (29-2), Nₜ is smaller than N.

$$I ( x , y ) \approx {\sum }_{k = 1}^{{N}_{t}} {λ}_{k} {\vert {\sum }_{( p , q ) ∈ K} m ( p , q ) {Φ}_{k} ( p - x , q - y ) \vert}^{2} \qquad ( 29 \text{-} 2 )$$

According to the third embodiment, the summation of square roots of the optical image intensity at a plurality of points on a wafer is chosen as the cost function and the optical image intensity is calculated by using a direct product vector of terms of the optical image intensity after the SOCS expansion at respective points on the wafer. Thus, the evaluation pattern X can be efficiently generated.

A fourth embodiment is explained. In the fourth embodiment, vectors (N number of M-dimensional real vectors (M>2)) are used for the cost function F as an algorithm (a method for calculating the evaluation pattern X that maximizes the optical image intensity) for maximizing a vector sum explained in the second and third embodiments.

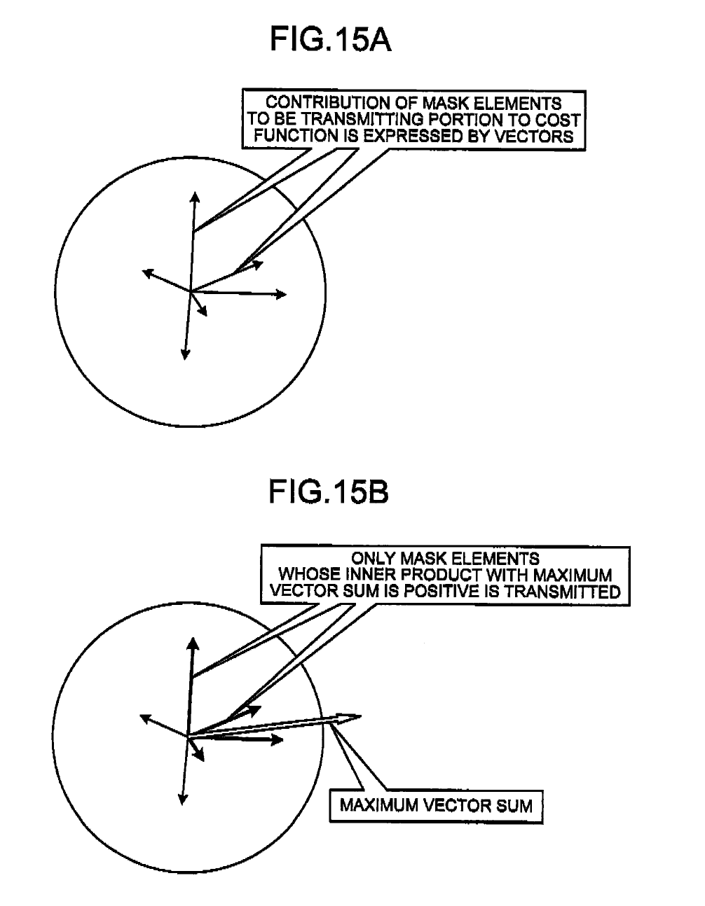

FIG. 15A is a schematic diagram for explaining a relationship between the cost function and the vector sum, and FIG. 15B is a schematic diagram for explaining a mask pattern generating method using the algorithm for maximizing the vector sum. As described above, in order to calculate the evaluation pattern X that maximizes the optical image intensity at coordinates (x, y) on the wafer, a combination of (p, q) that maximizes the sum of vectors (Expression (23)) having a dimension proportional to N needs to be calculated.

Because contribution of mask elements to be a transmitting portion to the cost function is expressed by vectors, the vector sum becomes large when the cost function is large (see FIG. 15A). In the present embodiment, mask elements that maximize the vector sum are calculated. First, the vector sum that becomes maximum is extracted from the vectors and only mask elements (meshes including a component that increases the cost function) whose inner product with the maximum vector sum is positive are transmitted, thereby calculating the evaluation pattern X (see FIG. 15B).

A method of maximizing the vector sum is specifically explained. A set Ω of N number of M-dimensional real vectors is expressed by Expression (30). The vector sum (Expression (31)) with respect to a subset K (K⊂Ω) of the set Ω is expressed by Expression (32).

$$\begin{matrix}Ω = \{ {\vec{x}}_{1} , {\vec{x}}_{2} , … , {\vec{x}}_{N} ∈ {ℛ}^{M} \} & ( 30 ) \\ {\vec{X} }_{K} & ( 31 ) \\ {\vec{X}}_{K} = {\sum }_{i ∈ K} {\vec{x}}_{i} & ( 32 )\end{matrix}$$

The subset K that maximizes the absolute value (Expression (33)) is defined as Kₘₐₓ. An algorithm for calculating Kₘₐₓ and Expression (34) is explained. If Kₘₐₓ and the like are calculated in a round-robin manner, calculation cost increases in an exponential fashion with respect to M and the calculation cost becomes O(2^{M}), in which M is a mesh interval in a mask according to the second or the third embodiment.

| X̅_{K}| (33)

|\vec{X}_{K}_{ₘₐₓ}| (34)

M needs to be sufficiently large to improve accuracy. Therefore, in practice, it is impossible to calculate in a round-robin manner. Thus, in the present embodiment, the calculation cost is suppressed to O(M) by using an approximate solution calculating method.

A calculation procedure of Kₘₐₓ and Expression (34) in the present embodiment is explained. First, P number of M-dimensional unit vectors are calculated (s1). The P number of M-dimensional unit vectors are expressed by Expression (35).

\vec{u}₁, \vec{u}₂, . . . \vec{u}ₚεR^{M} (35)

Next, a subset Kₚ of the set Ω is calculated for each of the calculated P number of M-dimensional unit vectors (Expression (36)) (p=1, 2, . . . , P) (s2). The subset Kₚ of the set Ω is expressed by Expression (37).

ūₚ (36)

Kₚ={ x̅ᵢ| x̅ᵢ·ūₚ>0 and x̅ᵢεΩ} (37)

The vector sum (p=1, 2, . . . , P) with respect to the subset Kₚ is calculated (s3). Next, the maximum value is obtained from among the absolute values (Expression (39)) of the P number of vectors. The maximum value is expressed by Expression (40).

$$\begin{matrix}{\vec{X}}_{P} = {\sum }_{i ∈ {K}_{p}} {\vec{x}}_{i} & ( 38 ) \\ \vert {\vec{X}}_{1} \vert , \vert {\vec{X}}_{2} \vert , … , \vert {\vec{X}}_{p} \vert & ( 39 ) \\ \vert {\vec{X}}_{{p}_{max}} \vert = max ( \vert {\vec{X}}_{1} \vert , \vert {\vec{X}}_{2} \vert , … , \vert {\vec{X}}_{p} \vert ) & ( 40 )\end{matrix}$$

K_{Pmax} is employed as an approximate solution of Kₘₐₓ, and Expression (41) is employed as an approximate solution of Expression (42). A high-accuracy approximate solution can be obtained by choosing a sufficiently large number as P that is the number of unit vectors.

\vec{X}ₚ (41)

X̅_{K}_{ₘₐₓ} (42)

When a direction of the unit vector (Expression (43)) is recognized in advance, a solution can be efficiently searched by choosing the direction approximately parallel to Expression (43) as directions of the P number of M-dimensional unit vectors.

$$\begin{matrix}\frac{{\vec{X}}_{{K}_{max}}}{\vert {\vec{X}}_{{K}_{max}} \vert} & ( 43 ) \\ {\vec{u}}_{1} , {\vec{u}}_{2} , … {\vec{u}}_{p} & ( 44 )\end{matrix}$$

When the direction of the unit vector (Expression (43)) is not recognized in advance, the directions of the P number of M-dimensional vectors (Expression (44)) are chosen to be isotropic. For example, if P=L^{M-1} (L is a natural number), the P number of unit vectors (Expression (36)) (p=1, 2, . . . , P) can be set as Expression (45) or Expression (46). When M=2, the unit vector is expressed by Expression (45), and when M=4, the unit vector is expressed by Expression (46).

$$\begin{matrix}{\vec{u}}_{ p} = ( \begin{matrix}cos \frac{2 π p}{L} \\ sin \frac{2 π p}{L}\end{matrix} ) ( p = 1 , 2 , … , L ) & ( 45 ) \\ {\vec{u}}_{ p } = ( \begin{matrix}\begin{matrix}\begin{matrix}cos [ \frac{2 π div ( p , L )}{L } ] cos [ \frac{2 πmod ( p , L )}{L} ] \\ sin [ \frac{2 π div ( p , L )}{L } ] cos [ \frac{2 πmod ( p , L )}{L} ]\end{matrix} \\ cos [ \frac{2 π div ( p , {L}^{2} )}{L } ] sin [ \frac{2 πmod ( p , L )}{L} ]\end{matrix} \\ sin [ \frac{2 π div ( p , {L}^{2} )}{L } ] sin [ \frac{2 πmod ( p , L )}{L} ]\end{matrix} ) ( p = 1 , 2 , … , {L}^{3} ) & ( 46 )\end{matrix}$$

where, div(p, L) and mod(p, L) are quotient and residue, respectively, when a natural number p is divided by the natural number L.

Expression (47) when the unit vectors are evaluated in the above method can ensure accuracy expressed by Expression (49) with respect to the true solution (Expression (48)).

$$\begin{matrix}{\vec{X}}_{ {P}_{max}} & ( 47 ) \\ {\vec{X} }_{{ }_{max}} & ( 48 ) \\ cos \frac{π}{{p}^{1 / ( M - 1 )}} \leq \frac{\vert {\vec{X}}_{{P}_{max}} \vert}{\vert {\vec{X}}_{{ }_{max}} \vert} \leq 1 & ( 49 )\end{matrix}$$

For example, when M=2 (when considering to maximize a two-dimensional vector sum), it is possible to obtain a high-accuracy solution candidate expressed by Expression (50) by evaluating unit vectors in 20 ways (P=20).

$$0.99 \leq \frac{\vert {\vec{X}}_{{P}_{max}} \vert}{\vert {\vec{X}}_{{ }_{max}} \vert} \leq 1 \qquad ( 50 )$$

According to the fourth embodiment, the maximum value of the vector sum is approximately calculated by using the P number of M-dimensional unit vectors, so that a high-accuracy solution can be easily calculated.

A fifth embodiment is explained. In the fifth embodiment, the evaluation target cell 21 (a functional block pattern) is verified by the evaluation pattern X (a cell-peripheral-environment evaluation pattern) generated by the evaluation-pattern generating apparatus 10 according to the first embodiment.

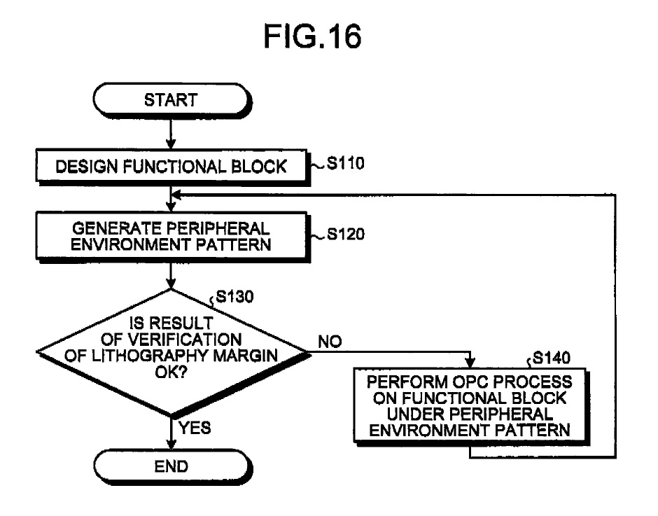

FIG. 16 is a flowchart of a procedure of a layout verification for the evaluation target cell 21. First, the evaluation target cell 21 as the functional block pattern is designed (Step S110). Then, the evaluation pattern X as a peripheral-environment evaluation pattern is generated by the evaluation-pattern generating apparatus 10 (Step S120). At this time, the evaluation-pattern generating apparatus 10 generates the evaluation pattern X while fixing the functional block pattern.

The generated evaluation pattern X is arranged on the periphery of the evaluation target cell 21, and a margin in the lithography process (hereinafter, “a lithography margin”) of the evaluation target cell 21 is verified. In verifying the lithography margin, for example, it is verified whether a condition such as a depth of focus (DOF), a mask error factor (MEF), a contrast, and a CD margin is within a process margin condition (Step S130). The lithography margin is verified by a simulating apparatus that simulates the lithography performance. Alternatively, the lithography margin can be verified by verifying a resist pattern obtained by performing an exposure process, a developing process, and the like through a mask on which the evaluation target cell 21 and the evaluation pattern X are arranged. Still alternatively, a pattern after etching can be verified instead of verifying the lithography margin.

If the result of the verification of the lithography margin is OK, i.e., if the margin is sufficient (Yes at Step S130), it is ensured that the generated lithography design pattern has sufficient robustness with respect to the peripheral environment pattern. Therefore, if the result of the verification of the lithography margin is OK, the verification process of the evaluation target cell 21 ends.

If the result of the verification of the lithography margin is not OK, i.e., if the margin is not sufficient (No at Step S130), it is determined that the generated lithography design pattern does not have sufficient robustness with respect to the peripheral environment pattern, and the evaluation target cell 21 is redesigned to be a pattern having sufficient lithography margin. Specifically, the generated evaluation pattern X is arranged on the periphery of the evaluation target cell 21, and the OPC process is performed on the evaluation target cell 21 in this state (Step S140). Whereby, the evaluation target cell 21 can be redesigned. Thereafter, the evaluation-pattern generating apparatus 10 according to the first embodiment generates a new evaluation pattern X with respect to the redesigned evaluation target cell 21 (Step S120).

The new evaluation pattern X is arranged on the periphery of the redesigned evaluation target cell 21 and the lithography margin of the redesigned evaluation target cell 21 is verified (Step S130). The processes from Step S120 to S140 are repeated until the result of the verification of the lithography margin becomes OK. By repeating this loop process, the evaluation target cell 21 having robustness sufficient with respect to the peripheral environment pattern can be obtained.

If the correction of the evaluation target cell 21 is very small, it is expected that the evaluation pattern X with respect to the redesigned evaluation target cell 21 be almost the same as the evaluation pattern X before the evaluation target cell 21 is redesigned. Therefore, the redesigned evaluation target cell 21 can be verified by using the evaluation pattern X generated before the evaluation target cell 21 is redesigned.

According to the fifth embodiment, the evaluation target cell 21 is verified by using the evaluation pattern X that can verify the stability sufficient to the peripheral environment of a pattern layout, so that the pattern layout (the evaluation target cell 21) can be verified that ensure the stability sufficient to the peripheral environment.

A sixth embodiment is explained. In the first embodiment, the mask transmittance distribution (a peripheral pattern) in the mesh grid 23 is calculated by using the cost function defined by the process margin at one or more evaluation points set in the evaluation target cell 21 (a functional block pattern). In the sixth embodiment, when calculating the mask transmittance distribution, the cost function is defined for each pattern variation (for each evaluation point) in the functional block pattern (a circuit pattern or a mask pattern). At this time, the evaluation-pattern generating apparatus 10 performs calculation of the mask transmittance distribution in the mesh grid 23 for each cost function that is defined for each pattern variation. In other words, in the preset embodiment, the mask transmittance (a peripheral pattern) in the mesh grid 23 is variable for each pattern variation.

According to the sixth embodiment, because the mask transmittance in the mesh grid 23 is variable for each pattern variation, robustness of the functional block pattern with respect to the peripheral pattern can be improved.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An evaluation pattern generating method comprising:
dividing a peripheral area of an evaluation target pattern that is any one of a circuit pattern of a semiconductor circuit and a mask pattern corresponding to the circuit pattern into a plurality of meshes;
first calculating including calculating an image intensity of the circuit pattern when the evaluation target pattern is transferred onto a wafer by a lithography process in a case where a mask function value is given to a predetermined mesh;
second calculating including calculating a mask function value of the mesh so that a cost function of the image intensity, in which an optical image characteristic amount that affects a transfer performance of the evaluation target pattern to the wafer is set to the image intensity, satisfies a predetermined reference when evaluating a lithography performance of the evaluation target pattern; and
generating a pattern corresponding to the mask function value at the mesh as an evaluation pattern of the evaluation target pattern, which is arranged on a periphery of the evaluation target pattern.

2. The evaluation pattern generating method according to claim 1, wherein the optical image characteristic amount includes any one of a focus sensitivity, a tilt of an optical image, a normalized optical image intensity log slope, and an optical image intensity in the circuit pattern.

3. The evaluation pattern generating method according to claim 1, wherein the second calculating includes
using any one of a function having linearity with respect to the mask function value of the mesh and a function that is approximate to the function having linearity with respect to the mask function value of the mesh as the cost function, and
calculating the mask function value of the mesh so that exposure light is transmitted or reflected from a mesh having a component that increases the cost function.

4. The evaluation pattern generating method according to claim 1, wherein the cost function is a function that is defined for each pattern variation in any one of the circuit pattern and the mask pattern.

5. The evaluation pattern generating method according to claim 1, wherein the second calculating includes calculating the mask function value so that a possibility of occurrence of a hot spot in any one of the circuit pattern and the mask pattern increases.

6. The evaluation pattern generating method according to claim 5, wherein the generating includes generating the evaluation pattern to fluctuate the transfer performance most with respect to the hot spot.

7. A computer program product for causing a computer to perform:
dividing a peripheral area of an evaluation target pattern that is any one of a circuit pattern of a semiconductor circuit and a mask pattern corresponding to the circuit pattern into a plurality of meshes;
first calculating including calculating an image intensity of the circuit pattern when the evaluation target pattern is transferred onto a wafer by a lithography process in a case where a mask function value is given to a predetermined mesh;
second calculating including calculating a mask function value of the mesh so that a cost function of the image intensity, in which an optical image characteristic amount that affects a transfer performance of the evaluation target pattern to the wafer is set to the image intensity, satisfies a predetermined reference when evaluating a lithography performance of the evaluation target pattern; and
generating a pattern corresponding to the mask function value at the mesh as an evaluation pattern of the evaluation target pattern, which is arranged on a periphery of the evaluation target pattern.

8. The computer program product according to claim 7, wherein the optical image characteristic amount includes any one of a focus sensitivity, a tilt of an optical image, a normalized optical image intensity log slope, and an optical image intensity in the circuit pattern.

9. The computer program product according to claim 7, wherein the second calculating includes
using any one of a function having linearity with respect to the mask function value of the mesh and a function that is approximate to the function having linearity with respect to the mask function value of the mesh as the cost function, and
calculating the mask function value of the mesh so that exposure light is transmitted or reflected from a mesh having a component that increases the cost function.

10. The computer program product according to claim 7, wherein the cost function is a function that is defined for each pattern variation in any one of the circuit pattern and the mask pattern.

11. The computer program product according to claim 7, wherein the second calculating includes calculating the mask function value so that a possibility of occurrence of a hot spot in any one of the circuit pattern and the mask pattern increases.

12. The computer program product according to claim 11, wherein the generating includes generating the evaluation pattern to fluctuate the transfer performance most with respect to the hot spot.

13. A pattern verifying method comprising:
dividing a peripheral area of an evaluation target pattern that is any one of a circuit pattern of a semiconductor circuit and a mask pattern corresponding to the circuit pattern into a plurality of meshes;
first calculating including calculating an image intensity of the circuit pattern when the evaluation target pattern is transferred onto a wafer by a lithography process in a case where a mask function value is given to a predetermined mesh;
second calculating including calculating a mask function value of the mesh so that a cost function of the image intensity, in which an optical image characteristic amount that affects a transfer performance of the evaluation target pattern to the wafer is set to the image intensity, satisfies a predetermined reference when evaluating a lithography performance of the evaluation target pattern;
generating a pattern corresponding to the mask function value at the mesh as an evaluation pattern of the evaluation target pattern, which is arranged on a periphery of the evaluation target pattern;
arranging the evaluation pattern on a periphery of the circuit pattern; and
verifying the lithography performance of the circuit pattern.

14. The pattern verifying method according to claim 13, wherein the optical image characteristic amount includes any one of a focus sensitivity, a tilt of an optical image, a normalized optical image intensity log slope, and an optical image intensity in the circuit pattern.

15. The pattern verifying method according to claim 13, wherein the second calculating includes
using any one of a function having linearity with respect to the mask function value of the mesh and a function that is approximate to the function having linearity with respect to the mask function value of the mesh as the cost function, and
calculating the mask function value of the mesh so that exposure light is transmitted or reflected from a mesh having a component that increases the cost function.

16. The pattern verifying method according to claim 13, wherein the cost function is a function that is defined for each pattern variation in any one of the circuit pattern and the mask pattern.

17. The pattern verifying method according to claim 13, wherein the second calculating includes calculating the mask function value so that a possibility of occurrence of a hot spot in any one of the circuit pattern and the mask pattern increases.

18. The pattern verifying method according to claim 17, wherein the generating includes generating the evaluation pattern to fluctuate the transfer performance most with respect to the hot spot.
